(19) United States
(12) Patent Application Publication
(10) Pub. No.: US 2009/0037595 A1
(43) Pub. Date: Feb. 5, 2009

(54) SELECTING AND APPLYING A COMMUNICATION VERSION

(75) Inventors: JEREMY R. BREAU, KANSAS CITY, MO (US); MANISH MANGAL, OVERLAND PARK, KS (US)

Correspondence Address: SPRINT COMMUNICATIONS COMPANY L.P., 6391 SPRINT PARKWAY, KSOPHT0101-Z2100, OVERLAND PARK, KS, 66251-2100, US

(73) Assignee: SPRINT COMMUNICATIONS COMPANY L.P., OVERLAND PARK, KS (US)

(21) Appl. No.: 11/831,725

(22) Filed: Jul. 31, 2007

(51) Int. Cl. G06F 15/173

(52) U.S. Cl. 709/230

(57) ABSTRACT

A method and system are provided to select a communication version. An embodiment of the method includes obtaining destination host address associated with a destination host attribute, such a domain name. Thereafter, an address version for each destination host address is identified. Upon identifying address versions for each destination host address, it is determined if the destination host address is associated with a preferred address version. In such an instance where the destination host address is associated with a preferred address version, such as Internet Protocol version 6, a corresponding communication version is selected.

### CROSS-REFERENCE TO RELATED APPLICATIONS

Not applicable.

### STATEMENT REGARDING FEDERALLY SPONSORED RESEARCH OR DEVELOPMENT

Not applicable.

### SUMMARY

This Summary is provided to introduce a selection of concepts in a simplified form that are further described below in the Detailed Description. Embodiments of the present invention are defined by the claims below. This Summary is intended to summarize embodiments of the invention and is not intended to limit the scope of the claims in any way.

Embodiments of the present invention provide a system and method for, among other things, selecting a communication version and applying the selected version to communicate with a destination host. The present invention has several practical applications in the technical arts including, by way of example only, providing a mechanism for selecting and applying Internet Protocol version 6 (IPv6) to a communication where both a source host and a destination host support IPv6. Such a mechanism allows the benefits of using IPv6 to be more frequently realized.

In a first illustrative aspect, one or more computer-readable media for selecting a communication version to be utilized during communication between a source host and a destination host, wherein the source host is a dual-stack host that supports a first communication version and a second communication version, is provided. The method includes obtaining one or more destination host addresses associated with a destination host attribute; identifying an address version for each of the destination host addresses obtained, wherein each address version comprises one of a first address version associated with the first communication version and a second address version associated with the second communication version; and determining if a destination host address comprises a preferred address version. In one embodiment, the preferred address version comprises the first address version and when one of the destination host addresses comprises the preferred address version, the method further comprises selecting the first communication version.

In a second aspect, a system for selecting a communication version to be utilized during communication between a source host and a destination host is provided. The source host is a dual-stack host that supports a first communication version and a second communication version. The system includes a destination host address obtaining component configured to obtain one or more destination host addresses associated with a destination host attribute. The system also includes an address version identifying component configured to identify an address version for each of the one or more destination host addresses obtained, wherein each address version comprises one of a first address version associated with the first communication version and a second address version associated with the second communication version. The system further includes a preference selecting component configured to determine if one of the one or more destination host addresses comprises a preferred address version. In one embodiment, the preferred address version comprises the first address version and when one of the one or more destination host addresses comprises of the preferred address version, the preference selecting component is further configured to select the first communication version associated with the first address version.

In an additional illustrative aspect, one or more computer-readable media having computer-executable instructions embodied thereon that, when executed, perform a method for selecting a communication version and applying the selected communication version to communicate with a destination host is provided. The method comprises indicating a desired destination host, wherein the desired destination host is indicated via a destination host attribute; requesting one or more destination host addresses associated with the desired destination host; receiving the one or more destination host addresses associated with the desired destination host; and determining if one of the one or more destination host addresses comprises a preferred address version. In one embodiment, when one of the one or more destination host addresses comprises the preferred address version, the method further comprises selecting a communication version associated with the preferred address version. The method further comprises applying the selected communication version so that communication between a source host and the destination host utilizes the selected communication version.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a schematic view of an exemplary communication environment suitable for use in implementing embodiments of the present invention;

FIG. 2 is a block diagram depicting an exemplary computing system for selecting a communication version and applying the selected communication version to communicate with a destination host, according to an embodiment of the present invention;

FIG. 3 is an exemplary flow diagram that illustrates selecting a communication version and applying the selected communication version to communicate with a destination host, according to an embodiment of the present invention; and

FIG. 4 is an exemplary flow diagram that illustrates selecting a communication version, according to an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention. The following is a list of these acronyms:
3G Third-Generation Wireless Technology
4G Fourth-Generation Cellular Communication System
AMPS Advanced Mobile Phone System
ASIC Application Specific Integrated Circuit
BSC Base Station Controller
BTS Base Transceiver Station
CD-ROM Compact Disk Read Only Memory
CDMA Code Division Multiple Access
DNS Domain Name System
DSL Digital Subscriber Line
DVD Digital Versatile Discs
EEPROM Electrically Erasable Programmable Read Only Memory
FAX Facsimile
GSM Global System for Mobile Communications
IP Internet Protocol
IPv4 Internet Protocol Version 4
IPv6 Internet Protocol Version 6
LAN Local Area Network
PCF Packet Control Function
PDA Personal Digital Assistant
PDSN Packet Data Serving Node
RAM Random Access Memory
ROM Read Only Memory
TV Television
TDMA Time Division Multiple Access
WI-FI Wireless Interface of Mobile Computing Devices
WIMAX Worldwide Interoperability for Microwave Access

Further, various technical terms are used throughout this description. A definition of such terms can be found in Newton's Telecom Dictionary by H. Newton, 21^{st} Edition (2005). These definitions are intended to provide a clearer understanding of the ideas disclosed herein but are not intended to limit the scope of the present invention. The definitions and terms should be interpreted broadly and liberally to the extent allowed the meaning of the words offered in the above-cited reference.

Embodiments of the present invention may be embodied as, among other things, a method, system, or computer-program product. Accordingly, the embodiments may take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

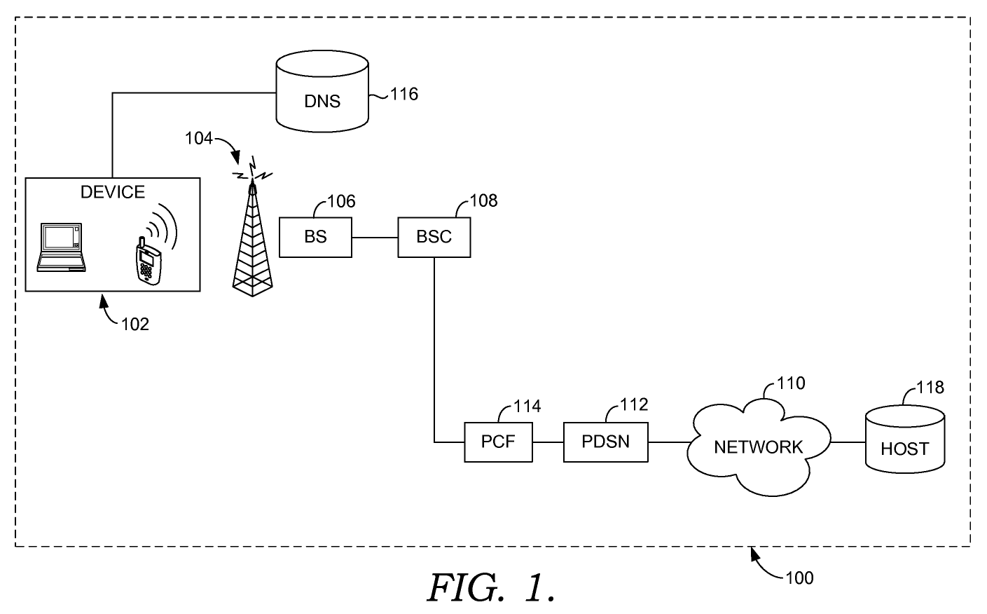

Referring to the drawings in generally, and initially to FIG. 1 in particular, an exemplary network environment suitable for use in implementing embodiments of the present invention is illustrated and designated generally as reference numeral 100. Network environment 100 is but one example of a suitable network environment and is not intended to suggest any limitation as to the scope of use or functionality of the invention. Neither should the network environment 100 be interpreted as having any dependency or requirement relating to any one or combination of components illustrated. In the network environment 100, for a device 102 to communicate with a host 118, the device 102 may communicate with a domain name server (DNS) 116 to obtain an Internet Protocol (IP) address of the host 118. The DNS 116 translates host names, e.g., domain names, into host addresses, e.g., IP addresses. The device 102 communicates over established radio frequencies through a cell tower 104 having a base transceiver station (BTS) 106, a number of which are typically connected to a base station controller (BSC) 108. The BTS 106 may communicate over a wireless air interface with one or more devices, such as device 102, located in the wireless coverage area. The communication between the BTS 106 and the device 102 may occur in a digital format, such as CDMA, TDMA, GSM, 3G, 4G, or 802.11x, or may occur in an analog format, such as AMPS. The BSC 108 manages the communication between a number of BTSs 106 and a limited number of devices 102 compatible with the network environment 100.

The device 102 may communicate with one or more networks 110, such as the Internet or an IP-based network, via a packet data serving node (PDSN) 112. A packet control function (PCF) 114 controls the transmission of packets between the BSC 108 and the PDSN 112. The PDSN 112 may connect BSC 108/PCF 114 to network 110. PDSN 112 may then act as a network access server, providing a device access to network 110. Alternatively or additionally, the network environment 100 may include other network elements for providing device access to network 110. The device 102 communicates with the host 118 via the network 110.

One skilled in the art will recognize that any network environment 100 having a network suitable for communicating between hosting devices, such as device 102 and host 118, may be utilized for implementing the present invention. Such a network environment 100 may, for example, utilize wireless technology or wired technology for network access. Wireless technology may include any wireless technology including, but not limited to 3G, 4G, WI-FI, WIMAX and the like. Wired technology includes, for example, wireline, DSL, and the like.

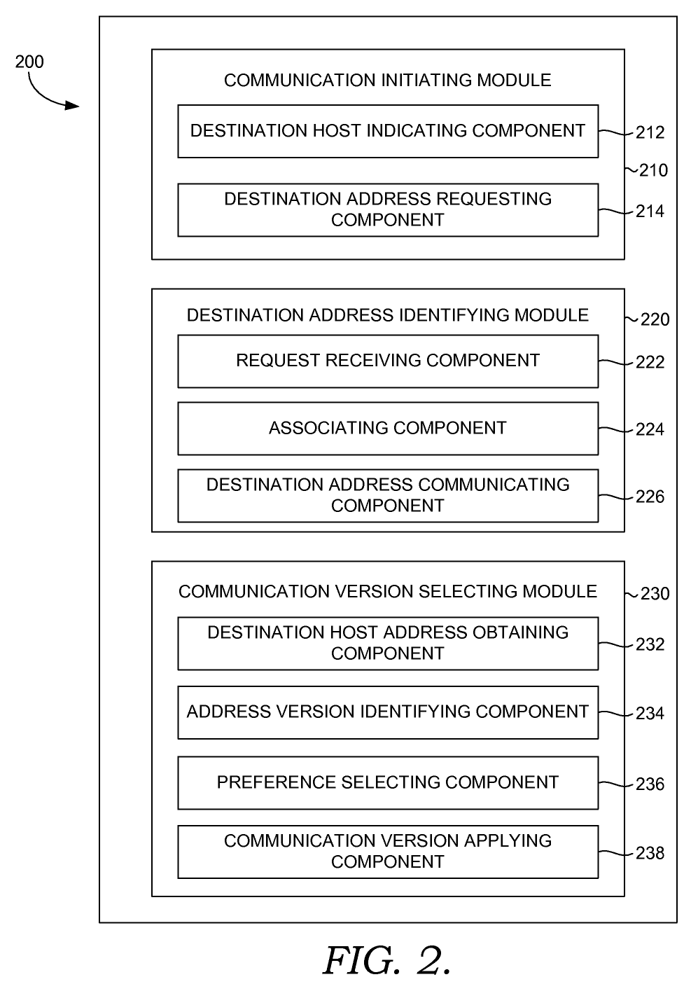

Referring now to FIG. 2, an exemplary computing system 200 for selecting a communication version and applying the selected communication version to communicate with a destination host. Selecting a communication version may assist with the migration from one communication version to another communication version such that a source host and a destination host are not required to upgrade to a communication version simultaneously.

As used herein, a communication version may refer to a version of any protocol used for communicating data including audio data, video data, text data, image data, or any other data type. In one embodiment, a communication version refers to any Internet Protocol version, such as Internet Protocol version 4 (IPv4) or Internet Protocol version 6 (IPv6). IPv4 utilizes IPv4 addresses to communicate and, similarly, IPv6 utilizes IPv6 addresses to communicate. As such, a source host with only an IPv4 address and a destination host with only an IPv6 address may not be able to communicate and an error message may result.

As used herein, the term “host” refers to any computing device that has two-way access to other computing devices on a network, such as the Internet, LAN, any IP-based network, or other public packet data network. Computing devices may include any device that performs one or more computing functions including, but not limited to, mobile phones; personal digital assistances (PDAs); televisions (TVs); laptops; desktop computers; facsimile (FAX) machines; digital versatile disc (DVD) players; servers, e.g., a web server; or any other computing device.

As used herein, a “source host” refers to a host, having at least one source address, that initiates communication with a destination host. A source host may be a multi-stack host such that it supports more than one communication version. In one embodiment, a source host may be a dual-stack host so as to support two communication versions. Such a dual-stack host may, for example, support IPv4 and IPv6 communication versions. A “destination host,” as used herein, refers to a host, having at least one destination address, with which a source host desires to communicate.

A host address refers to an address, such as an IP address, associated with a host, or portion thereof, that allows the host to communicate with other hosts. Accordingly, a “source address” refers to an address, such as an IP address, associated with a source host that allows the source host to communicate with other hosts. A “destination address,” refers to an address, such as an IP address, associated with a destination host that allows the destination host to communicate with other hosts. An IP address may refer to a numeric address having four number sets separated by dots, e.g., 1.123.12.123.

One skilled in the art will recognize that a host may have more than one host address. By way of example only, a virtual private server (VPS) may include one or more IP addresses. A host may also have multiple host address versions. A host address version may refer to a version of the host address. Such versions may include IPv4 address, IPv6 address, primary address, secondary address, internal address, external address, and the like. One skilled in the art will also recognize that a host may have one or more host addresses permanently assigned to the host. In the alternative, a host may have one or more host addresses dynamically assigned using a number of methods, such as a Simple IP process or a Mobile IP process.

As shown in FIG. 2, an exemplary computing system 200 includes a communication initiating module 210, a destination address identifying module 220, and a communication version selecting module 230. In some embodiments, one or more of the illustrated modules/components may be implemented as stand-alone applications. In other embodiments, one or more of the illustrated modules/components may be integrated directly into the operating system or an application of a server and/or an end-user device. It will be understood by those of ordinary skill in the art that the modules/components illustrated in FIG. 2 are exemplary in nature and in number and should not be construed as limited. Any number of modules/components may be employed to achieve the desired functionality within the scope of embodiments hereof. Further, modules/components may be located on any number of servers or computing devices.

The communication initiating module 210 is configured to initiate communication with a destination host. Such a communication initiating module 210, or portion thereof, may reside on a source host. In one embodiment, the communication initiating module 210 may include a destination host indicating component 212 and a destination address requesting component 214.

The destination host indicating component 212 may be configured to provide an indication of a desired destination host. The destination host may be any host, e.g., mobile phone, web server, or the like, having at least one destination address, with which the source host desires to communicate. In one embodiment, the destination host indicating component 212 may reside within an application on the source host. The destination host indicating component 212 may provide the indication of the destination host to, for example, a destination address requesting component 214.

A host attribute may be utilized to indicate a desired destination host. A host attribute may be any type of attribute, e.g., a value, text, a symbol, and the like, that is associated with a host, or portion thereof, and may be translated into or associated with a host address, such as an IP address. A host attribute may include a host name or a host number. A host name may refer to, for example, a domain name, a uniform resource locator (URL), and email address, and the like. A host number may refer to, for example, a phone number and the like.

In one embodiment, an indication of a destination host, e.g., a host attribute, may be based on a user's selection or input. For example, a user may select a host attribute, e.g., a domain name or phone number, from a list, table, menu, or the like. Alternatively, a user may input a host attribute, e.g., www.sprint.com, into an application. In such an embodiment, the indication may be provided, for example, to a destination address requesting component 214, automatically (e.g., as the host attribute is selected or entered) or upon a user indication (e.g., the user selects a “submit” button, “search” button, or the like).

The destination address requesting component 214 may be configured to request one or more destination addresses, e.g., destination IP addresses, associated with a destination host, such as a destination host indicated by destination host indicating component 212. Such a destination address requesting component 214 may, for example, reside within a DNS client on the source host. A request provided by destination address requesting component 212 may include data indicating the desired destination host or destination address. For example, the request may include a destination host name or a destination host number associated with the destination host. A request may also include data indicating the source host, source address, or source user, e.g., the user logged on to the source host. As such, the request may include a source host name, a source host number, a source address, e.g., a source IP address, or a user identifier.

The destination address requesting component 214 may request all destination addresses associated with a destination host, a portion of the destination addresses associated with a destination host, or specific destination addresses associated with a destination host. In one embodiment, the destination address requesting component 214 may request destination addresses based on a predetermined preference, such as a user, program developer, or program administrator preference. For example, each request set forth by destination address requesting component 214 may include a request for an IPv4 destination address and an IPv6 destination address associated with the destination host. Alternatively, an algorithm may be utilized by destination address requesting component 214 to determine the one or more destination addresses to request. Such an algorithm may incorporate policies associated with the user, the source host, the source host service provider, the destination host, the destination host service provider, and the like.

In an embodiment where multiple destination addresses associated with a destination host are desired, one request that encompasses all of the destination addresses may be utilized. By way of example, assuming an IPv4 destination address and an IPv6 destination address are desired, the destination address requesting component 214 may communicate one request that indicates a desire for an IPv4 destination address and an IPv6 destination address. Alternatively, in another embodiment, destination address requesting component 214 may utilize a separate request for each of the multiple destination address versions desired. For example, assuming an IPv4 destination address and an IPv6 destination address are desired, the destination address requesting component 214 may communicate two requests. As such, one request may indicate a desire for an IPv4 destination address while another request may indicate a desire for an IPv6 destination address.

The destination address identifying module 220 is configured to identify destination addresses, such as destination IP addresses. A destination address identifying module 220 may reside within a server utilized to translate a host attribute, e.g., a host name or a host number, into a host address, e.g., an IP address, or associate a host attribute with a host address. Such a server, e.g., DNS or telephone number mapping (ENUM), may utilize an algorithm and/or a lookup system to translate and/or associate a host attribute with a host address. DNS and ENUM are updated by hosts to maintain IP address accuracy. By way of example, assuming a host server adds an IPv6 address, the host server may accordingly update the DNS so that the IPv6 address may be associated with the corresponding host name.

In one embodiment, the destination address identifying module 220 may include a request receiving component 222, an associating component 224, and a destination address communicating component 226. The request receiving component 222 is configured to receive one or more requests for one or more destination addresses associated with a destination host. The requests received by the request receiving component 222 may include destination host attributes, source host attributes, source host addresses, user identifiers, or a combination thereof to indicate the desired destination and/or source.

The associating component 224 is configured to associate one or more destination addresses with a host attribute, such as a host attribute received by request receiving component 222. The associating component 224 may utilize an algorithm and/or a lookup system to associate one or more destination addresses with a host attribute. Where the associating component 224 resides on a DNS or ENUM server, the associating component 224 may utilize databases stored therewith that include IP addresses mapped to corresponding host names, e.g., domain names.

The request received by the request receiving component 222 may indicate the desired number of destination addresses and/or the type of destination address versions to be associated with a host attribute. In such an instance, the associating component 224 may associate the host attribute received with the desired number of destination address and/or destination address versions. For example, in response to a request for an IPv4 address version and an IPv6 address version, the associating component 224 may associate the host attribute with one IPv4 address, if available, and one IPv6 address, if available.

In the alternative, the number of destination addresses and/or destination address versions to be associated with a host attribute may be set forth by the associating component 224. In such an embodiment, the associating component 224 may determine the number and/or version of destination addresses based on an algorithm or a predetermined preference indicated by a user, a program developer, or a program administrator. In one embodiment, for example, the associating component 224 may automatically associate a host attribute with one IPv4 address, if available, and one IPv6 address, if available.

The destination address communicating component 226 is configured to communicate at least a portion of the one or more destination addresses associated with a host attribute. Such a destination address communicating component 226 may communicate the one or more destination addresses to, for example, a communication version selecting module 230 such that a communication version may be selected. In instances where no destination addresses are associated with a host attribute, an error message may be communicated. In one embodiment, the destination address communicating component 226 may communicate each of the associated destination addresses. In an alternative embodiment, the destination address communicating component 226 may communicate a portion of the associated destination addresses. To determine whether to communicate all of the associated destination addresses or a portion of the associated destination addresses, an algorithm or the destination address request received by the request receiving component 222 may be utilized.

The communication version selecting module 230 is configured to select the communication version that should be utilized for communication between the source host and the destination host. Such a communication version selecting module 230 may reside within the source host. In one embodiment, the communication version selecting module 230 may include a destination host address obtaining component 232, an address version identifying component 234, a preference selecting component 236, and a communication version applying component 238.

The destination host address obtaining component 232 is configured to obtain one or more destination host addresses associated with a destination host attribute, e.g., a domain name. The destination host address obtaining component 232 may obtain one or more destination host addresses associated with a destination host attribute by receiving, retrieving, generating, or identifying such destination host addresses. In one embodiment, destination host address obtaining component 232 may receive one or more destination host addresses from, for example, the destination address identifying module 220.

The address version identifying component 234 is configured to identify an address version for the one or more destination host addresses, such as the destination host addresses obtained by destination host address obtaining component 232. Versions of destination host addresses may include, for example, IPv4, IPv6, primary, secondary, internal, external, and the like. In one embodiment, a destination host address version may be identified based on an address version embedded in or attached with the destination host address obtained by destination host address obtaining component 232. In such an embodiment, the destination host address obtaining component 232 may also obtain information pertaining to the destination host address, such as the address version. Alternatively, the obtained destination host address may have a specific format that indicates the address version. In another embodiment, the address version identifying component 234 may determine the address version, for example, via an algorithm.

The preference selecting component 236 is configured to determine if a destination host address, such as a destination host address obtained by the destination host address obtaining component 232, is a preferred address version. Such a determination may be based on the address versions identified by address version identifying component. A preferred address version may be set forth via an algorithm, a user, a program developer, a program administrator, or the like. Such an algorithm, user, program developer, program administrator, and the like may incorporate one or more policies based on the source host, destination host, user, and the like.

In an embodiment where a source host is a single-stack host such that it only supports one communication version, the preferred destination host address version may be the destination host address version that is the same as the source host address version supported by the source host so that the source host and destination host may communicate. For example, assume a source host has an IPv4 address version and a destination host has both an IPv4 address version and an IPv6 address version. In such a case, the preferred address version may be the IP address version of IPv4 because both the source host and the destination host may support such addresses.

In an embodiment where a source host is a dual-stack host or a multi-stack host such that the host may support more than one communication version, the preferred address version may be the most recently developed address version, the most efficient address version, the address version with the most availability, the address version that complies with associated policies, the address version utilized by both a host source and a destination source, if only one such version exists, or the like. For example, assume a source host is a dual-stack host such that the host has an IPv4 address and an IPv6 address and a destination host also has an IPv4 address and an IPv6 address. In such a case, the preferred address version may be the IP address version of IPv6 because the IPv6 address may have a higher priority during the transition from IPv4 to IPv6.

If the preference selecting component 236 determines that at least one destination host address is a preferred address version, the preference selecting component 236 may also be configured to select the communication version to be utilized during communication between a source host and a destination host. In one embodiment, the communication version that is associated with the preferred address version may be selected. For example, the IPv6 communication version is associated with IPv6 addresses. As such, in an instance where an IPv6 address is the preferred address version, the IPv6 communication version may be selected.

The communication version applying component 238 is configured to apply the communication version, such as the communication version selected by the preference selecting component 236, such that communication between the source host and the destination host may occur. As such, to communicate, the communication version applying component 238 may utilize the version stack associated with the preferred communication version. For example, assuming IPv6 is the communication version selected for communication with a destination host, the communication version applying component 238 may send data to the IPv6 stack for communication to the destination host.

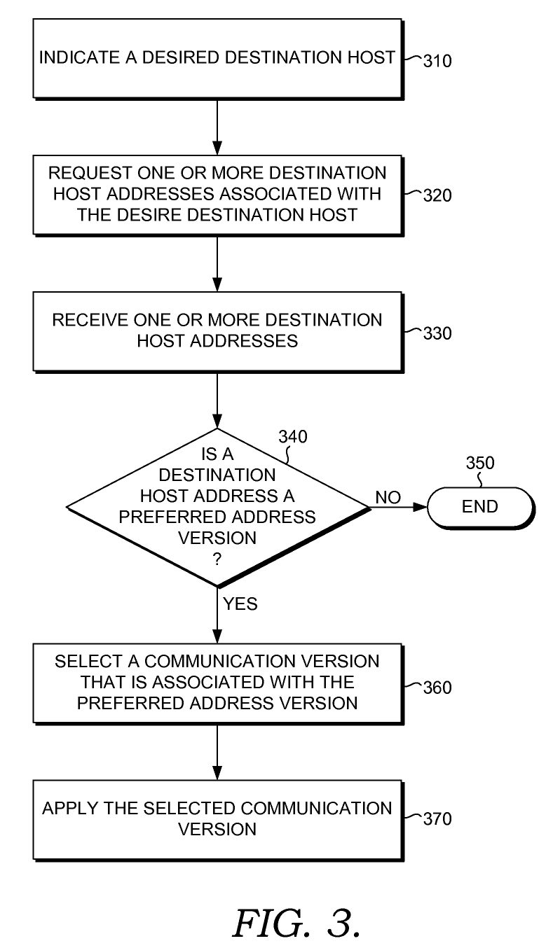

With reference to FIG. 3, a flow diagram is shown illustrating a method 300 for selecting a communication version and applying the selected communication version to communicate with a destination host. Initially, as indicated at block 310, a desired destination host is indicated. Subsequently, as indicated at block 320, one or more destination host addresses associated with the desired destination host are requested. As indicated at block 330, one or more destination host addresses are received. Thereafter, as indicated at block 340, it is determined if a destination host address is a preferred address version. If it is determined that there is not a destination host address that is a preferred address version, the method ends, as indicated at block 350. If, however, it is determined that there is a destination host address that is a preferred address version, a communication version that is associated with the preferred address version is selected, as indicated at block 360. As indicated at block 370, the selected communication version is applied so that communication between a source host and the destination host utilizes the selected communication version.

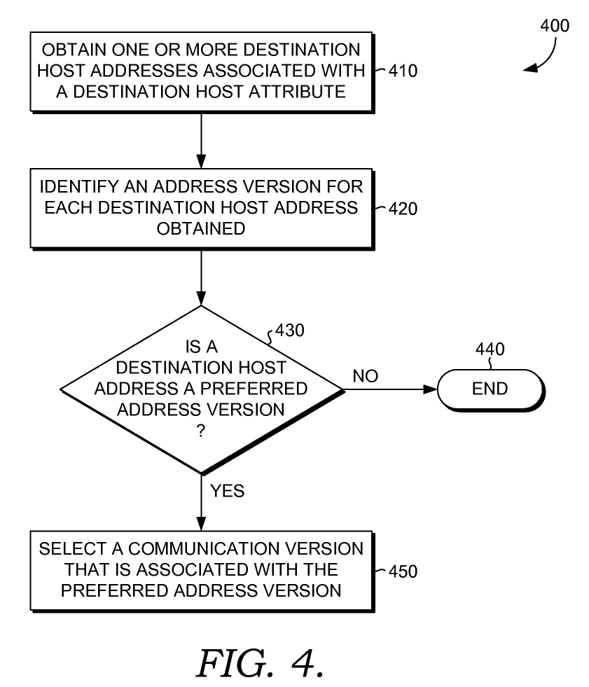

Turning now to FIG. 4, a flow diagram is shown illustrating a method 400 for selecting a communication version to be used for communication between a source host and a destination host, in accordance with an embodiment of the present invention. Initially, as indicated at block 410, one or more destination host addresses associated with a destination host attribute are obtained. Subsequently, as indicated at block 420, an address version for each destination host address obtained at block 410 is identified. As indicated at block 430, it is then determined if any particular destination host address is a preferred address version. If it is determined that there is not a destination host address that is a preferred address version, the method ends, as indicated at block 440. If, however, it is determined that there is a destination host address that is a preferred address version, a communication version that is associated with the preferred address version is selected. This is indicated at block 450.

By way of example only, assume a source host is dual-stack host and thereby supports an IPv4 communication version and an IPv6 communication version. A first destination host address 1.1.1.1 and a second destination host address 2.2.2.2 associated with a destination host attribute, such as www.example.com, are obtained. Address versions for the first destination host address 1.1.1.1 and the second destination host address 2.2.2.2 are identified. Assume, for example, that the first destination host address 1.1.1.1 is an IPv4 address version and the second destination host address 2.2.2.2 is an IPv6 address version. Further assume that an IPv6 address version is the preferred address version. In such a case, the IPv6 communication version is selected to communicate with the destination host as it is associated with the preferred address version, i.e., IPv6 address version.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and sub-combinations and are contemplated within the scope of the claims. Not all steps listed in the various figures need be carried out in the specific order described.

The invention claimed is:

1. One or more computer-readable media having computer-executable instructions embodied thereon that, when executed perform a method for selecting a communication version to be utilized during communication between a source host and a destination host, wherein the source host is a dual-stack host that supports a first communication version and a second communication version, the method comprising:
obtaining one or more destination host addresses associated with a destination host attribute;
identifying an address version for each of the one or more destination host addresses obtained, wherein each address version comprises one of a first address version associated with the first communication version and a second address version associated with the second communication version; and
determining if one of the one or more destination host addresses comprises a preferred address version, wherein the preferred address version comprises the first address version, and wherein when one of the one or more destination host addresses comprises the preferred address version, the method further comprises selecting the first communication version.

2. The one or more computer-readable media of claim 1, wherein the destination host attribute comprises a domain name.

3. The one or more computer-readable media of claim 1, wherein the destination host attribute comprises a telephone number.

4. The one or more computer-readable media of claim 1, wherein the one or more destination host addresses are received from a domain name server.

5. The one or more computer-readable media of claim 1, wherein the first address version comprises an Internet Protocol version 6.

6. The one or more computer-readable media of claim 1, wherein the second address version comprises an Internet Protocol version 4.

7. A system for selecting a communication version to be utilized during communication between a source host and a destination host, wherein the source host is a dual-stack host that supports a first communication version and a second communication version, the system comprising:
a destination host address obtaining component configured to obtain one or more destination host addresses associated with a destination host attribute;
an address version identifying component configured to identify an address version for each of the one or more destination host addresses obtained, wherein each address version comprises a first address version associated with the first communication version or a second address version associated with the second communication version; and
a preference selecting component configured to determine if one of the one or more destination host addresses comprises a preferred address version, wherein the preferred address version comprises the first address version, and wherein when one of the one or more destination host addresses comprises of the preferred address version, the preference selecting component is further configured to select the first communication version associated with the first address version.

8. The system of claim 7, wherein each of the one or more destination host addresses comprises a destination host Internet Protocol address.

9. The system of claim 7 further comprising a communication version applying component configured to apply the first communication version so that the source host and the destination host may communicate.

10. The system of claim 7, wherein the first communication version comprises an Internet Protocol version 6 and the second communication version comprises an Internet Protocol version 4.

11. The system of claim 7, wherein the one or more destination host addresses are received from a domain name server.

12. One or more computer-readable media having computer-executable instructions embodied thereon that, when executed perform a method for selecting a communication version and applying the selected communication version to communicate with a destination host, the method comprising:
indicating a desired destination host, wherein the desired destination host is indicated via a destination host attribute;
requesting one or more destination host addresses associated with the desired destination host;
receiving the one or more destination host addresses associated with the desired destination host;
determining if one of the one or more destination host addresses comprises a preferred address version, wherein when one of the one or more destination host addresses comprises the preferred address version, the method further comprises selecting a communication version associated with the preferred address version; and
applying the selected communication version so that communication between a source host and the destination host utilizes the selected communication version.

13. The computer-readable media of claim 12, wherein the desired destination host comprises a web server.

14. The computer-readable media of claim 12, wherein the destination host attribute comprises a domain name.

15. The computer-readable media of claim 12, wherein each of the one or more destination host addresses comprises an Internet Protocol addresses.

16. The computer-readable media of claim 12, wherein a domain name server communicates the one or more destination host addresses received.

17. The computer-readable media of claim 12, wherein the preferred address version comprises Internet Protocol version 6.

18. The computer-readable media of claim 17, wherein an Internet Protocol version 6 stack is utilized to provide communication between a source host and the destination host.

19. The computer-readable media of claim 12 further comprising identifying an address version for each of the one or more destination host addresses, wherein each address version comprises a first address version associated with the first communication version or a second address version associated with the second communication version.

20. The computer-readable media of claim 12, wherein the preferred address version is set forth base on an algorithm, a user preference, a program developer preference, a program administrator preference, or a combination thereof.
